(19) United States
(12) Patent Application Publication
(10) Pub. No.: US 2025/0045621 A1
(43) Pub. Date: Feb. 6, 2025

(54) System, Method, Computer Program Product for Operating a Gated Multilayer Perceptron Machine Learning Model Architecture

(71) Applicant: Visa International Service Association, San Francisco, CA (US)

(72) Inventors: Yuzhong Chen, Palo Alto, CA (US); Mahashweta Das, Campbell, CA (US); Hao Yang, San Jose, CA (US)

(21) Appl. No.: 18/229,272

(22) Filed: Aug. 2, 2023

(51) Int. Cl. G06N 20/00

(52) U.S. Cl. CPC G06N 20/00

(57) ABSTRACT

Provided is a system that includes a processor to receive interaction data associated with a plurality of interactions, generate a first intermediate embedding, a second intermediate embedding, and a third intermediate embedding using at least one machine learning model, provide the first intermediate embedding as an input to a gating machine learning model to generate an intermediate classification of the first intermediate embedding, multiply the intermediate classification of the first intermediate embedding, the second intermediate embedding, and the third intermediate embedding to provide an intermediate product of outputs, combine the first intermediate embedding and the intermediate product of outputs to provide a combined final input, and generate an output classification label of the combined final input based on providing the combined final input to a head machine learning model. Methods and computer program products are also provided.

### BACKGROUND

### 1. Field

The present disclosure relates generally to the use multilayer perceptron machine learning models and, in some non-limiting embodiments or aspects, to systems, methods, and computer program products for operating a gated multilayer machine learning model architecture.

### 2. Technical Considerations

A neural network (e.g., an artificial neural network) may be used for classification/prediction tasks in a variety of applications, such as facial recognition, fraud detection, disease diagnosis, navigation of self-driving cars, and/or the like. In such applications, a neural network (NN) may receive an input and generate predictions based on the input, for example, the identity of an individual, whether a payment transaction is fraudulent or not fraudulent, whether a disease is associated with one or more genetic markers, whether an object in a field of view of a self-driving car is in the self-driving car's path, and/or the like.

A multilayer perceptron (MLP) may refer to a fully connected class of feedforward neural networks. In some instances, an MLP may consist of at least three layers of nodes: an input layer, a hidden layer, and an output layer. Except for the input nodes, each node may include an artificial neuron that uses a non-linear activation function. In some instances, an MLP may utilize a chain rule based supervised learning technique called backpropagation (e.g., reverse mode of automatic differentiation) for training. The multiple layers and non-linear activation may be a point of distinction between an MLP and a linear perceptron.

However, an MLP may not effectively use context information regarding data instances in a dataset. For example, an MLP may not be able to use clustering information of data instances in each class of a plurality of classes that are included in a dataset. In this way, an MLP may not be accurate and/or may be inefficient for some types of classification problems.

### SUMMARY

Accordingly, systems, devices, products, apparatus, and/or methods for operating a gated multilayer machine learning model architecture are disclosed that overcome some or all of the deficiencies of the prior art.

Further embodiments are set forth in the following numbered clauses:

Clause 1: A computer-implemented method for operating a gated multilayer perceptron machine learning model, comprising: receiving, with at least one processor, interaction data associated with a plurality of interactions, the interaction data comprising a plurality of features; generating, with at least one processor, a first intermediate embedding based on providing a first input to at least one machine learning model, wherein the first input comprises the plurality of features; generating, with at least one processor, a second intermediate embedding based on providing a second input to the at least one machine learning model, wherein the second input comprises a center value of a first classification of the interaction data; generating, with at least one processor, a third intermediate embedding based on providing a third input to the at least one machine learning model, wherein the third input comprises a center value of a second classification of the interaction data; providing, with at least one processor, the first intermediate embedding as an input to a gating machine learning model to generate an intermediate classification of the first intermediate embedding, wherein the gating machine learning model is configured to provide a prediction of a classification label of an input as an output; multiplying, with at least one processor, the intermediate classification of the first intermediate embedding, the second intermediate embedding, and the third intermediate embedding to provide an intermediate product of outputs; combining, with at least one processor, the first intermediate embedding and the intermediate product of outputs to provide a combined final input; and generating, with at least one processor, an output classification label of the combined final input based on providing the combined final input to a head machine learning model, wherein the head machine learning model is configured to provide a prediction of a classification label of an input as an output.

Clause 2: The computer-implemented method of clause 1, wherein generating the first intermediate embedding comprises: generating the first intermediate embedding based on providing the first input to a first machine learning model.

Clause 3: The computer-implemented method of clause 1 or 2, wherein generating the second intermediate embedding comprises: generating the second intermediate embedding based on providing the second input to a second machine learning model; and wherein generating the third intermediate embedding comprises: generating the third intermediate embedding based on providing a third input to a third machine learning model; wherein the first machine learning model, the second machine learning model, and the third machine learning model are each neural network machine learning models; and wherein an input layer of each of the first machine learning model, the second machine learning model, and the third machine learning model are the same size.

Clause 4: The computer-implemented method of any of clauses 1-3, further comprising: training the gating machine learning model and the head machine learning model using a binary cross-entropy loss function.

Clause 5: The computer-implemented method of any of clauses 1-4, further comprising: determining the center value of the first classification of the interaction data; and determining the center value of the second classification of the interaction data.

Clause 6: The computer-implemented method of any of clauses 1-5, wherein combining the first intermediate embedding and the intermediate product of outputs to provide the combined final input comprises: concatenating the first intermediate embedding and the intermediate product of outputs to provide the combined final input.

Clause 7: The computer-implemented method of any of clauses 1-6, wherein the gating machine learning model and the head machine learning model each comprises a binary classification machine learning model.

Clause 8: A system, comprising: at least one processor programmed or configured to: receive interaction data associated with a plurality of interactions, the interaction data comprising a plurality of features; generate a first intermediate embedding based on providing a first input to at least one machine learning model, wherein the first input comprises the plurality of features; generate a second intermediate embedding based on providing a second input to the at least one machine learning model, wherein the second input comprises a center value of a first classification of the interaction data; generate a third intermediate embedding based on providing a third input to the at least one machine learning model, wherein the third input comprises a center value of a second classification of the interaction data; provide the first intermediate embedding as an input to a gating machine learning model to generate an intermediate classification of the first intermediate embedding, wherein the gating machine learning model is configured to provide a prediction of a classification label of an input as an output; multiply the intermediate classification of the first intermediate embedding, the second intermediate embedding, and the third intermediate embedding to provide an intermediate product of outputs; combine the first intermediate embedding and the intermediate product of outputs to provide a combined final input; and generate an output classification label of the combined final input based on providing the combined final input to a head machine learning model, wherein the head machine learning model is configured to provide a prediction of a classification label of an input as an output.

Clause 9: The system of clause 8, wherein, when generating the first intermediate embedding, the at least one processor is programmed or configured to: generate the first intermediate embedding based on providing the first input to a first machine learning model.

Clause 10: The system of clause 8 or 9, wherein, when generating the second intermediate embedding, the at least one processor is programmed or configured to: generate the second intermediate embedding based on providing the second input to a second machine learning model; and wherein, when generating the third intermediate embedding, the at least one processor is programmed or configured to: generate the third intermediate embedding based on providing a third input to a third machine learning model; wherein the first machine learning model, the second machine learning model, and the third machine learning model are each neural network machine learning models; and wherein an input layer of each of the first machine learning model, the second machine learning model, and the third machine learning model are the same size.

Clause 11: The system of any of clauses 8-10, further wherein the at least one processor is further programmed or configured to: train the gating machine learning model and the head machine learning model using a binary cross-entropy loss function.

Clause 12: The system of any of clauses 8-11, wherein the at least one processor is further programmed or configured to: determine the center value of the first classification of the interaction data; and determine the center value of the second classification of the interaction data.

Clause 13: The system of any of clauses 8-12, wherein, when combining the first intermediate embedding and the intermediate product of outputs to provide the combined final input, the at least one processor is programmed or configured to: concatenate the first intermediate embedding and the intermediate product of outputs to provide the combined final input.

Clause 14: The system of any of clauses 8-13, wherein the gating machine learning model and the head machine learning model each comprises a binary classification machine learning model.

Clause 15: A computer program product comprising at least one non-transitory computer-readable medium including one or more instructions that, when executed by at least one processor, cause the at least one processor to: receive interaction data associated with a plurality of interactions, the interaction data comprising a plurality of features; generate a first intermediate embedding based on providing a first input to at least one machine learning model, wherein the first input comprises the plurality of features; generate a second intermediate embedding based on providing a second input to the at least one machine learning model, wherein the second input comprises a center value of a first classification of the interaction data; generate a third intermediate embedding based on providing a third input to the at least one machine learning model, wherein the third input comprises a center value of a second classification of the interaction data; provide the first intermediate embedding as an input to a gating machine learning model to generate an intermediate classification of the first intermediate embedding, wherein the gating machine learning model is configured to provide a prediction of a classification label of an input as an output; multiply the intermediate classification of the first intermediate embedding, the second intermediate embedding, and the third intermediate embedding to provide an intermediate product of outputs; combine the first intermediate embedding and the intermediate product of outputs to provide a combined final input; and generate an output classification label of the combined final input based on providing the combined final input to a head machine learning model, wherein the head machine learning model is configured to provide a prediction of a classification label of an input as an output.

Clause 16: The computer program product of clause 15, wherein, the one or more instructions that cause the at least one processor to generate the first intermediate embedding, cause the at least one processor to: generate the first intermediate embedding based on providing the first input to a first machine learning model.

Clause 17: The computer program product of clause 15 or 16, wherein, the one or more instructions that cause the at least one processor to generate the second intermediate embedding, cause the at least one processor to: generate the second intermediate embedding based on providing the second input to a second machine learning model; and wherein, the one or more instructions that cause the at least one processor to generate the third intermediate embedding, cause the at least one processor to: generate the third intermediate embedding based on providing a third input to a third machine learning model; wherein the first machine learning model, the second machine learning model, and the third machine learning model are each neural network machine learning models; and wherein an input layer of each of the first machine learning model, the second machine learning model, and the third machine learning model are the same size.

Clause 18: The computer program product of any of clauses 15-17, wherein the one or more instructions further cause the at least one processor to: train the gating machine learning model and the head machine learning model using a binary cross-entropy loss function.

Clause 19: The computer program product of any of clauses 15-18, wherein the one or more instructions further cause the at least one processor to: determine the center value of the first classification of the interaction data; and determine the center value of the second classification of the interaction data.

Clause 20: The computer program product of any of clauses 15-19, wherein, the one or more instructions that cause the at least one processor to combine the first intermediate embedding and the intermediate product of outputs to provide the combined final input, cause the at least one processor to: concatenate the first intermediate embedding and the intermediate product of outputs to provide the combined final input.

Clause 21: The computer program product of any of clauses 15-20, wherein the gating machine learning model and the head machine learning model each comprises a binary classification machine learning model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for operating a gated multilayer machine learning model architecture; and

FIGS. 4A-4C are diagrams of non-limiting embodiments or aspects of an implementation of a process for operating a gated multilayer machine learning model architecture.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the present disclosure are directed to systems, methods, and computer program products for operating a gated multilayer machine learning model architecture. In some non-limiting embodiments or aspects, a model management system may be programmed or configured to receive interaction data associated with a plurality of interactions, the interaction data comprising a plurality of features, generate a first intermediate embedding based on providing a first input to at least one machine learning model, where the first input comprises the plurality of features, generate a second intermediate embedding based on providing a second input to the at least one machine learning model, wherein the second input comprises a center value of a first classification of the interaction data, generate a third intermediate embedding based on providing a third input to the at least one machine learning model, wherein the third input comprises a center value of a second classification of the interaction data, provide the first intermediate embedding as an input to a gating machine learning model to generate an intermediate classification of the first intermediate embedding, wherein the gating machine learning model is configured to provide a prediction of a classification label of an input as an output, multiply the intermediate classification of the first intermediate embedding, the second intermediate embedding, and the third intermediate embedding to provide an intermediate product of outputs, combine the first intermediate embedding and the intermediate product of outputs to provide a combined final input, and generate an output classification label of the combined final input based on providing the combined final input to a head machine learning model, wherein the head machine learning model is configured to provide a prediction of a classification label of an input as an output.

In some non-limiting embodiments or aspects, when generating the first intermediate embedding, the model management system may generate the first intermediate embedding based on providing the first input to a first machine learning model. In some non-limiting embodiments or aspects, when generating the second intermediate embedding, the model management system may generate the second intermediate embedding based on providing the second input to a second machine learning model, and, when generating the third intermediate embedding, the model management system may generate the third intermediate embedding based on providing a third input to a third machine learning model, where the first machine learning model, the second machine learning model, and the third machine learning model are each neural network machine learning models and where an input layer of each of the first machine learning model, the second machine learning model, and the third machine learning model are the same size. In some non-limiting embodiments or aspects, the model management system may train the gating machine learning model and the head machine learning model using a binary cross-entropy loss function. In some non-limiting embodiments or aspects, the model management system may determine the center value of the first classification of the interaction data and determine the center value of the second classification of the interaction data.

In some non-limiting embodiments or aspects, when combining the first intermediate embedding and the intermediate product of outputs to provide the combined final input, the model management system may concatenate the first intermediate embedding and the intermediate product of outputs to provide the combined final input. In some non-limiting embodiments or aspects, the gating machine learning model and the head machine learning model each comprises a binary classification machine learning model.

In this way, the model management system may provide for a gated multilayer machine learning model architecture that can be used for classification applications, such as fraud protection (e.g., fraud detection and/or fraud prevention), which be able to use clustering information of data instances in each class of a plurality of classes that are included in a dataset to provide a result. Accordingly, the gated multilayer machine learning model architecture is more accurate and requires less computational resources to implement than a standard multilayer perceptron.

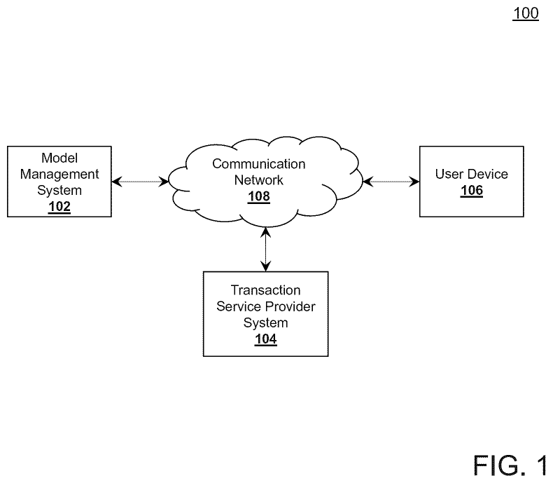

Referring now to FIG. 1, FIG. 1 is a diagram of an example environment 100 in which devices, systems, and/or methods, described herein, may be implemented. As shown in FIG. 1, environment 100 may include model management system 102, transaction service provider system 104, user device 106, and communication network 108. Model management system 102, transaction service provider system 104, and/or user device 106 may interconnect (e.g., establish a connection to communicate) via wired connections, wireless connections, or a combination of wired and wireless connections.

Model management system 102 may include one or more devices configured to communicate with transaction service provider system 104 and/or user device 106 via communication network 108. For example, model management system 102 may include a server, a group of servers, and/or other like devices. In some non-limiting embodiments or aspects, model management system 102 may be associated with a transaction service provider system (e.g., may be operated by a transaction service provider as a component of a transaction service provider system, may be operated by a transaction service provider independent of a transaction service provider system, etc.), as described herein. Additionally or alternatively, model management system 102 may generate (e.g., train, validate, re-train, and/or the like), store, and/or implement (e.g., operate, provide inputs to and/or outputs from, and/or the like) one or more machine learning models. For example, model management system 102 may generate one or more machine learning models by fitting (e.g., validating) one or more machine learning models against data used for training (e.g., training data). In some non-limiting embodiments or aspects, model management system 102 may generate, store, and/or implement one or more machine learning models that are provided for a production environment (e.g., a real-time or runtime environment used for providing inferences based on data in a live situation). In some non-limiting embodiments or aspects, model management system 102 may be in communication with a data storage device, which may be local or remote to model management system 102. In some non-limiting embodiments or aspects, model management system 102 may be capable of receiving information from, storing information in, transmitting information to, and/or searching information stored in the data storage device.

Transaction service provider system 104 may include one or more devices configured to communicate with model management system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system, as discussed herein. In some non-limiting embodiments or aspects, model management system 102 may be a component of transaction service provider system 104.

User device 106 may include a computing device configured to communicate with model management system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

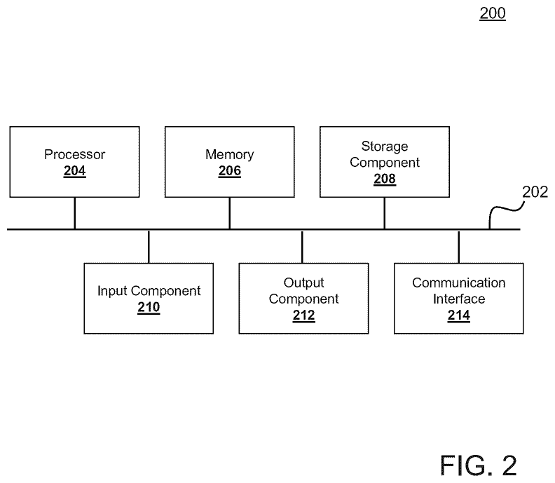

Referring now to FIG. 2, FIG. 2 is a diagram of example components of a device 200. Device 200 may correspond to model management system 102 (e.g., one or more devices of model management system 102), transaction service provider system 104 (e.g., one or more devices of transaction service provider system 104), and/or user device 106. In some non-limiting embodiments or aspects, model management system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

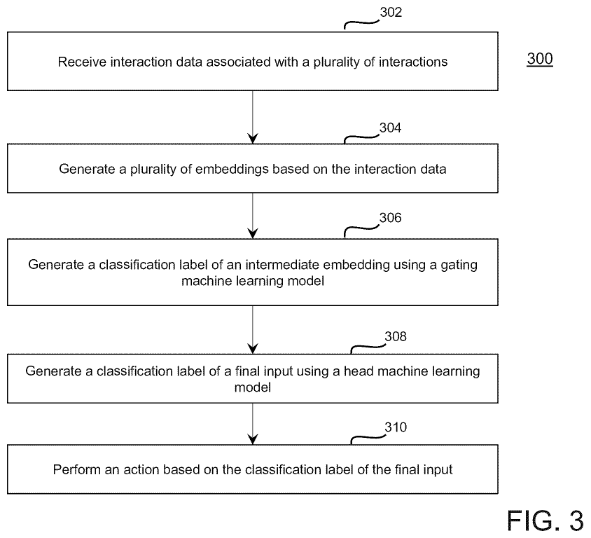

Referring now to FIG. 3, FIG. 3 is a flowchart of a non-limiting embodiment or aspect of a process 300 for operating a gated multilayer machine learning model architecture. In some non-limiting embodiments or aspects, one or more of the steps of process 300 may be performed (e.g., completely, partially, etc.) by model management system 102 (e.g., one or more devices of model management system 102). In some non-limiting embodiments or aspects, one or more of the steps of process 300 may be performed (e.g., completely, partially, etc.) by another device or a group of devices separate from or including model management system 102 (e.g., one or more devices of model management system 102), transaction service provider system 104 (e.g., one or more devices of transaction service provider system 104), and/or user device 106.

As shown in FIG. 3, at step 302, process 300 includes receiving interaction data associated with a plurality of interactions. For example, model management system 102 may receive the interaction data associated with a plurality of interactions. In some non-limiting embodiments or aspects, the interaction data may include a plurality of features (e.g., at least 5 features, at least 10 features, at least 20 features, etc.). In some non-limiting embodiments or aspects, model management system 102 may receive the interaction data from transaction service provide system 104 and/or user device 106. In some non-limiting embodiments or aspects, model management system 102 may receive the interaction data from a system or device other than or in addition to transaction service provide system 104 and/or user device 106, such as from a merchant system, an issuer system, an acquirer system, and/or the like.

In some non-limiting embodiments or aspects, model management system 102 may receive the interaction data associated with (e.g., included in) a request for inference for a machine learning model (e.g., a production machine learning model, such as a gated multilayer perceptron) and perform a feature engineering procedure on the interaction data to produce an input to the machine learning model. In some non-limiting embodiments or aspects, the interaction data may be associated with a task for which a production machine learning model may provide an inference. In some non-limiting embodiments or aspects, the interaction data may be associated with financial service tasks. For example, the interaction data may be associated with a token service task, an authentication task (e.g., a 3D secure authentication task), a fraud detection task, a fraud prevention task, and/or the like. In some non-limiting embodiments or aspects, the machine learning model may include a machine learning model that has been trained and/or validated (e.g., tested) and that may be used to generate inferences (e.g., prediction), such as real-time inferences, runtime inferences, and/or the like.

In some non-limiting embodiments or aspects, the interaction data may include data associated with a plurality of payment transactions. In some non-limiting embodiments or aspects, model management system 102 may generate the interaction data. For example, model management system 102 may generate the interaction data from a dataset that includes a plurality of feature values of a plurality of features. In some non-limiting embodiments or aspects, the plurality of features may be associated with a plurality of payment transactions.

As shown in FIG. 3, at step 304, process 300 includes generating a plurality of embeddings based on the interaction data. For example, model management system 102 may generate the plurality of embeddings based on the interaction data. In some non-limiting embodiments or aspects, model management system 102 may generate a first intermediate embedding based on providing at least one first input to a first machine learning model, generate a second intermediate embedding based on providing at least one second input to a second machine learning model, and/or generate a third intermediate embedding based on providing at least one third input to a third machine learning model.

In some non-limiting embodiments or aspects, the first machine learning model, the second machine learning model, and the third machine learning model may be the same machine learning model. Alternatively, the first machine learning model, the second machine learning model, and the third machine learning model may be different machine learning models. In some non-limiting embodiments or aspects, the first machine learning model, the second machine learning model, and the third machine learning model may act as a plurality of filters, and the plurality of filters may share parameters with regard to the machine learning models. In some non-limiting embodiments or aspects, the first machine learning model, the second machine learning model, and/or the third machine learning model may include a neural network machine learning model. In some non-limiting embodiments or aspects, an input layer of each of the first machine learning model, the second machine learning model, and the third machine learning model are the same size.

In some non-limiting embodiments or aspects, the first input may include a plurality of features (e.g., a plurality of features included in the interaction data, a plurality of values of a plurality of features, a plurality of values of a plurality of features associated with a plurality of payment transactions, etc.). In some non-limiting embodiments or aspects, the second input may include a center value of a first classification of the interaction data. For example, the second input may include a center value (e.g., a value at a center of a cluster, a value at a feature space cluster center, etc.) of a first classification of a plurality of features (e.g., a plurality of feature values of a plurality of features) of the interaction data. In some non-limiting embodiments or aspects, model management system 102 may determine the center value of the first classification of the interaction data and/or determine the center value of the second classification of the interaction data.

In some non-limiting embodiments or aspects, the first classification may be a classification of a binary classification, such as a positive classification (e.g., a numerical one, such as “1”). In some non-limiting embodiments or aspects, the third input may include a center value of a second classification of the interaction data. For example, the third input may include a center value of a second classification of a plurality of features of the interaction data. In some non-limiting embodiments or aspects, the second classification may be a classification of a binary classification, such as a negative classification (e.g., a numerical zero, such as a “0”).

As shown in FIG. 3, at step 306, process 300 includes generating a classification label of an intermediate embedding using a gating machine learning model. For example, model management system 102 may generate the classification label of an intermediate embedding using a gating machine learning model.

In some non-limiting embodiments or aspects, model management system 102 may provide the first intermediate embedding as an input to a gating machine learning model to generate an intermediate classification of the first intermediate embedding. In some non-limiting embodiments or aspects, the gating machine learning model is configured to provide a prediction of a classification label of an input, such as the first intermediate embedding, as an output. In some non-limiting embodiments or aspects, the gating machine learning model may include a binary classification machine learning model.

As shown in FIG. 3, at step 308, process 300 includes generating a classification label of a final input using a head machine learning model. For example, model management system 102 may generate the classification label of a final input using a head machine learning model. In some non-limiting embodiments or aspects, model management system 102 may multiply an intermediate classification of the first intermediate embedding, the second intermediate embedding, and the third intermediate embedding to provide an intermediate product of outputs.

In some non-limiting embodiments or aspects, model management system 102 may combine the first intermediate embedding and the intermediate product of outputs to provide the final output (e.g., a combined final input). For example, model management system 102 may concatenate the first intermediate embedding and the intermediate product of outputs to provide the final input.

In some non-limiting embodiments or aspects, model management system 102 may generate an output classification label of the final input based on providing the combined final input to a head machine learning model. In some non-limiting embodiments or aspects, the head machine learning model is configured to provide a prediction of a classification label of an input as an output. In some non-limiting embodiments or aspects, the head machine learning model may include a binary classification machine learning model.

In some non-limiting embodiments or aspects, model management system 102 may train the gating machine learning model and/or the head machine learning model based on a loss function. For example, model management system 102 may train the gating machine learning model and/or the head machine learning model using a binary cross-entropy loss function. In some non-limiting embodiments or aspects, the loss function may be based on the loss at the outputs of the gating machine learning model and the head machine learning model.

As shown in FIG. 3, at step 310, process 300 includes performing an action based on the classification label of the final input. For example, model management system 102 may perform an action based on the classification label of the final input. In some non-limiting embodiments or aspects, model management system 102 may perform a procedure associated with protection of an account of a user (e.g., a user associated with user device 106) based on the classification label of the final input. For example, if the classification label of the final input indicates that the procedure is necessary, model management system 102 may perform the procedure associated protection of the account of the user. In such an example, if the classification label of the final input indicates that the procedure is not necessary, model management system 102 may forego performing the procedure associated protection of the account of the user. In some non-limiting embodiments or aspects, model management system 102 may execute a fraud protection procedure based on the classification label of the final input.

In some non-limiting embodiments or aspects, model management system 102 may perform the action by providing the classification label of the final input as a response to a request for inference. In some non-limiting embodiments or aspects, model management system 102 may perform the action by generating and transmitting an alert (e.g., an alert message) based on the classification label of the final input. For example, model management system 102 may perform the action by generating and transmitting an alert to user device 106 (e.g., a user associated with user device 106, such as a subject matter expert).

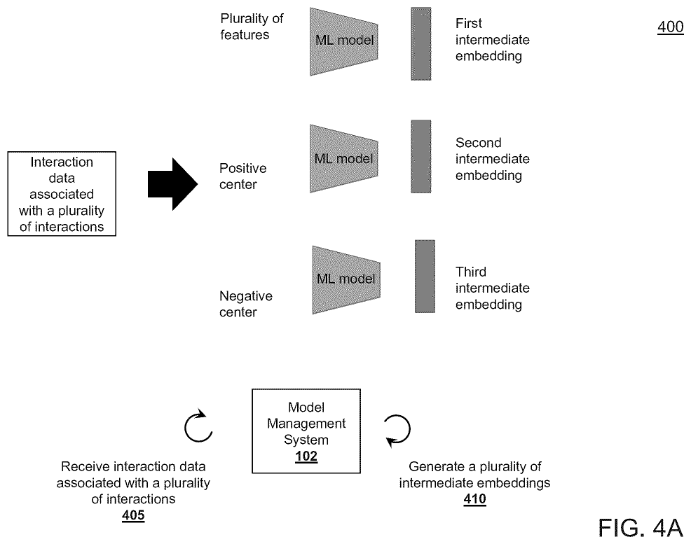

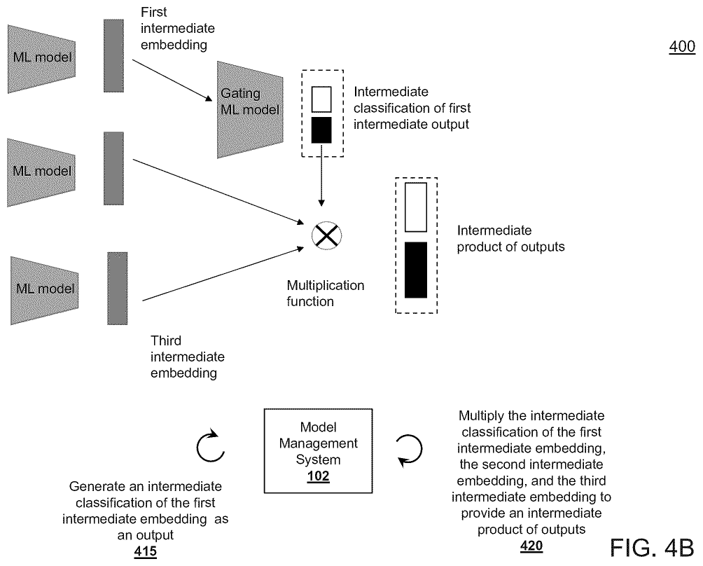

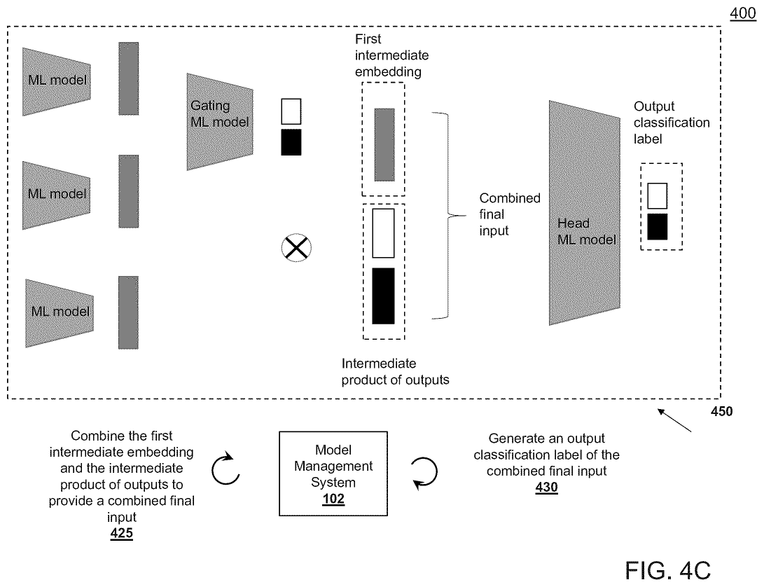

Referring now to FIGS. 4A-4C, FIGS. 4A-4C are diagrams of non-limiting embodiments or aspects of an implementation 400 of a process (e.g., process 300) for operating a gated multilayer perceptron machine learning model architecture.

As shown by reference number 405 in FIG. 4A, model management system 102 may receive interaction data associated with a plurality of interactions. In some non-limiting embodiments or aspects, the interaction data may include a plurality of features (e.g., at least 5 features, at least 10 features, at least 20 features, etc.). In some non-limiting embodiments or aspects, model management system 102 may determine a center value of a first classification of the interaction data and/or determine a center value of a second classification of the interaction data based on receiving the interaction data.

As further shown by reference number 410 in FIG. 4A, model management system 102 may generate a plurality of intermediate embeddings. For example, model management system 102 may generate the plurality of embeddings based on the interaction data. In some non-limiting embodiments or aspects, model management system 102 may generate a first intermediate embedding based on providing at least one first input to a first machine learning model, generate a second intermediate embedding based on providing a second input to a second machine learning model, and generate a third intermediate embedding based on providing a third input to a third machine learning model. In some non-limiting embodiments or aspects, the first input may include a plurality of features (e.g., a plurality of features included in the interaction data, a plurality of values of a plurality of features, a plurality of values of a plurality of features associated with a plurality of payment transactions, etc.). In some non-limiting embodiments or aspects, the second input may include a center value of a first classification, such as a positive classification in a binary classification, of the interaction data (e.g., “positive center”). In some non-limiting embodiments or aspects, the third input may include a center value of a second classification, such as a negative classification in a binary classification, of the interaction data (e.g., “negative center”).

As shown by reference number 415 in FIG. 4B, model management system 102 may generate an intermediate classification of the first intermediate embedding as an output. For example, model management system 102 may provide the first intermediate embedding as an input to a gating machine learning model (e.g., “gating ML model”) to generate an intermediate classification of the first intermediate embedding. In some non-limiting embodiments or aspects, the gating machine learning model may include a binary classification machine learning model. As further shown by reference number 420 in FIG. 4B, model management system 102 may multiply (e.g., using a multiplication function) the intermediate classification of the first intermediate embedding, the second intermediate embedding, and the third intermediate embedding to provide an intermediate product of outputs.

As shown by reference number 425 in FIG. 4C, model management system 102 may combine the first intermediate embedding and the intermediate product of outputs to provide a combined final input. For example, model management system 102 may concatenate the first intermediate embedding and the intermediate product of outputs to provide the combined final input. As further shown by reference number 430 in FIG. 4C, model management system 102 may generate an output classification label of the combined final input.

In some non-limiting embodiments or aspects, model management system 102 may generate an output classification label of the final input based on providing the combined final input to a head machine learning model (e.g., “head ML model”). In some non-limiting embodiments or aspects, the head machine learning model may include a binary classification machine learning model.

In some non-limiting embodiments or aspects, model management system 102 may perform an action based on the output classification label of the final input. In some non-limiting embodiments or aspects, model management system 102 may perform a procedure associated protection of an account of a user (e.g., a user associated with user device 106) based on the output classification label of the final input. For example, if the output classification label of the final input indicates that the procedure is necessary, model management system 102 may perform the procedure associated protection of the account of the user. In such an example, if the output classification label of the final input indicates that the procedure is not necessary, model management system 102 may forego performing the procedure associated protection of the account of the user.

As further shown in FIG. 4C, the components of ML models, embeddings, a gating ML model, multiplication operations (e.g., functions), a head ML model, and the like, may comprise gated multilayer machine learning model architecture 450.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system, comprising:
at least one processor programmed or configured to:
receive interaction data associated with a plurality of interactions, the interaction data comprising a plurality of features;
generate a first intermediate embedding based on providing a first input to at least one machine learning model, wherein the first input comprises the plurality of features;
generate a second intermediate embedding based on providing a second input to the at least one machine learning model, wherein the second input comprises a center value of a first classification of the interaction data;
generate a third intermediate embedding based on providing a third input to the at least one machine learning model, wherein the third input comprises a center value of a second classification of the interaction data;
provide the first intermediate embedding as an input to a gating machine learning model to generate an intermediate classification of the first intermediate embedding, wherein the gating machine learning model is configured to provide a prediction of a classification label of an input as an output;
multiply the intermediate classification of the first intermediate embedding, the second intermediate embedding, and the third intermediate embedding to provide an intermediate product of outputs;
combine the first intermediate embedding and the intermediate product of outputs to provide a combined final input; and
generate an output classification label of the combined final input based on providing the combined final input to a head machine learning model, wherein the head machine learning model is configured to provide a prediction of a classification label of an input as an output.

2. The system of claim 1, wherein, when generating the first intermediate embedding, the at least one processor is programmed or configured to:
generate the first intermediate embedding based on providing the first input to a first machine learning model.

3. The system of claim 2, wherein, when generating the second intermediate embedding, the at least one processor is programmed or configured to:
generate the second intermediate embedding based on providing the second input to a second machine learning model; and
wherein, when generating the third intermediate embedding, the at least one processor is programmed or configured to:
generate the third intermediate embedding based on providing a third input to a third machine learning model;
wherein the first machine learning model, the second machine learning model, and the third machine learning model are each neural network machine learning models; and
wherein an input layer of each of the first machine learning model, the second machine learning model, and the third machine learning model are the same size.

4. The system of claim 1, wherein the at least one processor is further programmed or configured to:
train the gating machine learning model and the head machine learning model using a binary cross-entropy loss function.

5. The system of claim 1, wherein the at least one processor is further programmed or configured to:
determine the center value of the first classification of the interaction data; and
determine the center value of the second classification of the interaction data.

6. The system of claim 1, wherein, when combining the first intermediate embedding and the intermediate product of outputs to provide the combined final input, the at least one processor is programmed or configured to:
concatenate the first intermediate embedding and the intermediate product of outputs to provide the combined final input.

7. The system of claim 1, wherein the gating machine learning model and the head machine learning model each comprises a binary classification machine learning model.

8. A computer-implemented method for operating a gated multilayer perceptron machine learning model, comprising:
receiving, with at least one processor, interaction data associated with a plurality of interactions, the interaction data comprising a plurality of features;
generating, with at least one processor, a first intermediate embedding based on providing a first input to at least one machine learning model, wherein the first input comprises the plurality of features;
generating, with at least one processor, a second intermediate embedding based on providing a second input to the at least one machine learning model, wherein the second input comprises a center value of a first classification of the interaction data;
generating, with at least one processor, a third intermediate embedding based on providing a third input to the at least one machine learning model, wherein the third input comprises a center value of a second classification of the interaction data;
providing, with at least one processor, the first intermediate embedding as an input to a gating machine learning model to generate an intermediate classification of the first intermediate embedding, wherein the gating machine learning model is configured to provide a prediction of a classification label of an input as an output;
multiplying, with at least one processor, the intermediate classification of the first intermediate embedding, the second intermediate embedding, and the third intermediate embedding to provide an intermediate product of outputs;
combining, with at least one processor, the first intermediate embedding and the intermediate product of outputs to provide a combined final input; and
generating, with at least one processor, an output classification label of the combined final input based on providing the combined final input to a head machine learning model, wherein the head machine learning model is configured to provide a prediction of a classification label of an input as an output.

9. The computer-implemented method of claim 8, wherein generating the first intermediate embedding comprises:
generating the first intermediate embedding based on providing the first input to a first machine learning model.

10. The computer-implemented method of claim 9, wherein generating the second intermediate embedding comprises:
generating the second intermediate embedding based on providing the second input to a second machine learning model; and
wherein generating the third intermediate embedding comprises:
generating the third intermediate embedding based on providing a third input to a third machine learning model;
wherein the first machine learning model, the second machine learning model, and the third machine learning model are each neural network machine learning models; and
wherein an input layer of each of the first machine learning model, the second machine learning model, and the third machine learning model are the same size.

11. The computer-implemented method of claim 8, further comprising:
training the gating machine learning model and the head machine learning model using a binary cross-entropy loss function.

12. The computer-implemented method of claim 8, further comprising:
determining the center value of the first classification of the interaction data; and
determining the center value of the second classification of the interaction data.

13. The computer-implemented method of claim 8, wherein combining the first intermediate embedding and the intermediate product of outputs to provide the combined final input comprises:
concatenating the first intermediate embedding and the intermediate product of outputs to provide the combined final input.

14. The computer-implemented method of claim 8, wherein the gating machine learning model and the head machine learning model each comprises a binary classification machine learning model.

15. A computer program product comprising at least one non-transitory computer-readable medium including one or more instructions that, when executed by at least one processor, cause the at least one processor to:
receive interaction data associated with a plurality of interactions, the interaction data comprising a plurality of features;
generate a first intermediate embedding based on providing a first input to at least one machine learning model, wherein the first input comprises the plurality of features;
generate a second intermediate embedding based on providing a second input to the at least one machine learning model, wherein the second input comprises a center value of a first classification of the interaction data;
generate a third intermediate embedding based on providing a third input to the at least one machine learning model, wherein the third input comprises a center value of a second classification of the interaction data;
provide the first intermediate embedding as an input to a gating machine learning model to generate an intermediate classification of the first intermediate embedding, wherein the gating machine learning model is configured to provide a prediction of a classification label of an input as an output;
multiply the intermediate classification of the first intermediate embedding, the second intermediate embedding, and the third intermediate embedding to provide an intermediate product of outputs;
combine the first intermediate embedding and the intermediate product of outputs to provide a combined final input; and
generate an output classification label of the combined final input based on providing the combined final input to a head machine learning model, wherein the head machine learning model is configured to provide a prediction of a classification label of an input as an output.

16. The computer program product of claim 15, wherein, the one or more instructions that cause the at least one processor to generate the first intermediate embedding, cause the at least one processor to:
generate the first intermediate embedding based on providing the first input to a first machine learning model.

17. The computer program product of claim 16, wherein, the one or more instructions that cause the at least one processor to generate the second intermediate embedding, cause the at least one processor to:
generate the second intermediate embedding based on providing the second input to a second machine learning model; and
wherein, the one or more instructions that cause the at least one processor to generate the third intermediate embedding, cause the at least one processor to:
generate the third intermediate embedding based on providing a third input to a third machine learning model;
wherein the first machine learning model, the second machine learning model, and the third machine learning model are each neural network machine learning models; and
wherein an input layer of each of the first machine learning model, the second machine learning model, and the third machine learning model are the same size.

18. The computer program product of claim 15, wherein the one or more instructions further cause the at least one processor to:
train the gating machine learning model and the head machine learning model using a binary cross-entropy loss function.

19. The computer program product of claim 15, wherein the one or more instructions further cause the at least one processor to:
determine the center value of the first classification of the interaction data; and
determine the center value of the second classification of the interaction data.

20. The computer program product of claim 15, wherein, the one or more instructions that cause the at least one processor to combine the first intermediate embedding and the intermediate product of outputs to provide the combined final input, cause the at least one processor to:
concatenate the first intermediate embedding and the intermediate product of outputs to provide the combined final input.
